(19) United States
(12) Patent Application Publication
(10) Pub. No.: US 2024/0085248 A1
(43) Pub. Date: Mar. 14, 2024

(54) TEMPERATURE MEASUREMENT DEVICE

(71) Applicant: Nippon Telegraph and Telephone Corporation, Tokyo (JP)

(72) Inventors: Hiraku Toida, Tokyo (JP); Kosuke Kakuyanagi, Tokyo (JP); Shiro Saito, Tokyo (JP)

(21) Appl. No.: 18/261,819

(22) PCT Filed: Feb. 10, 2021
(86) PCT No.: PCT/JP2021/004915

§ 371 Date: Jul. 17, 2023

(51) Int. Cl. G01K 7/36

(52) U.S. Cl. CPC G01K 7/36

(57) ABSTRACT

A temperature measuring device includes a spin group made up of a group a plurality of particles having spins, and a superconducting quantum bit which detects magnetization of the spin group. The spin group is disposed at an asymmetric position on the superconducting quantum bit. The temperature measuring device also includes a magnetic field application unit which applies a magnetic field to the spin group in a direction horizontal to the superconducting quantum bit, and a measuring unit which measures energy of the superconducting quantum bit.

### CROSS-REFERENCE TO RELATED APPLICATIONS

This application is a national phase entry of PCT Application No. PCT/JP2021/004915, filed on Feb. 10, 2021, which application is hereby incorporated herein by reference.

### TECHNICAL FIELD

The present invention relates to a temperature measuring device using superconducting quantum bits.

### BACKGROUND

Temperature measurement techniques are utilized in any scene. Generally, the temperature measurement is performed by measuring physical quantities of various substances having temperature dependence. The larger the amount of the substance is, the higher the measurement accuracy of the physical quantity is. However, there is a problem that the larger the amount of substance is, the lower the spatial resolution of the temperature measurement becomes, and the larger the heat capacity becomes, the more the influence on an measuring object brought into contact with a thermometer becomes. Therefore, it is desirable that the thermometer is as small as possible. However, if the thermometer is made small, the measurement accuracy is deteriorated. In particular, a high-precision thermometer on a sub-micrometer scale is not realized in a temperature range sufficiently lower than a Debye temperature at which the temperature dependence of the lattice such as thermal expansion is lost.

In physical property measurement, highly accurate temperature measurement to 1 K or less is required. The most widely used thermometer is a resistance thermometer that utilizes the property that the electrical resistance of a semiconductor increases with decrease in temperature. The resistance thermometer is characterized in that it can be easily used only by attaching a resistor of several millimeters in magnitude to an measuring object and performing wiring. However, since a relationship between the resistance value and the temperature is unknown until measurement, it is essential to obtain calibration information compared with a standard thermometer. In addition, due to noise or the like mixed in from the measuring system and self-heating of measurement, the resistance thermometer has a problem that it is difficult to accurately measure the temperature to several tens of mK or less.

As a thermometer for realizing highly accurate temperature measurement, there is a thermometer for detecting a change in magnetization of a paramagnetic material with temperature using a superconducting quantum interference element. This technique utilizes the fact that the change of the magnetization rate due to the temperature follows Curie's law, and it is possible to measure the temperature with high accuracy (NPL 1). However, in this technique, since the thermometer has a magnitude of about several tens of mm, and when temperature measurement with a nano-device or the like is considered, this magnitude is not considered to be sufficiently small, and improvement therein is desired.

When the temperature of the measuring object is estimated from the measured value of the temperature by a thermometer having a large magnitude, the thermometer and the measuring object need to be close to an equilibrium state. On the other hand, when the system is in an unbalanced state such as with heat generation in the measuring object, the temperature is difficult to be estimated, and a difference may occur between the temperature indicated by the thermometer and the actual temperature of the measuring object. When the spatial distribution of the temperature is desired to be measured, a resolution equal to or smaller than the magnitude of the thermometer cannot be obtained.

### CITATION LIST

### Non Patent Literature

NPL 1—D. A. Sergatskov et al., “New Paramagnetic Susceptibility Thermometers for Fundamental Physics Measurements”, AIP Conference Proceedings, 684, pp. 1009-1013, 2003.

### SUMMARY

### Technical Problem

On the basis of the above-mentioned background, there is a demand for a thermometer in which the magnitude of the temperature measuring element is small and which can be installed in the vicinity of a measuring object. Since the thermal resistance depends on an area and the thermal capacity depends on a volume, since the thermal capacity with respect to the thermal resistance becomes small when the magnitude of the temperature measuring element is small, a high-speed response can be expected. However, the smaller the magnitude of the temperature measuring element is, the lower the accuracy of the temperature measuring element is, and therefore, a small and highly sensitive measuring technique is required.

Embodiments of the present invention have been made to solve the above-mentioned problems, and an object of embodiments of the present invention is to provide a temperature measuring device which has a small magnitude and can be installed in the vicinity of an measuring object.

### Solution to Problem

A temperature measuring device according to embodiments of the present invention includes a spin group made up of a group a plurality of particles having spins; a superconducting quantum bit which detects magnetization of the spin group; a magnetic field application unit which applies a magnetic field to the spin group in a direction horizontal to the superconducting quantum bit; and a measuring unit which measures energy of the superconducting quantum bit.

### Advantageous Effects of Embodiments of Invention

As described above, according to embodiments of the present invention, since a spin group including a plurality of particles having spins is used as a temperature measuring element and magnetization of the spin group is detected by a superconducting quantum bit, it is possible to provide a temperature measuring device that is small in magnitude and can be installed in the vicinity of the measuring object.

### BRIEF DESCRIPTION OF THE DRAWINGS

FIG. 1 is a configuration diagram illustrating a configuration of the temperature measuring device according to an embodiment of the present invention.

FIG. 2 is a configuration diagram illustrating a configuration of the temperature measuring device according to the embodiment of the present invention.

FIG. 3 is a characteristics diagram showing changes in temperature and reading probability when quantum coherence of quantum bits is utilized.

### DETAILED DESCRIPTION OF ILLUSTRATIVE EMBODIMENTS

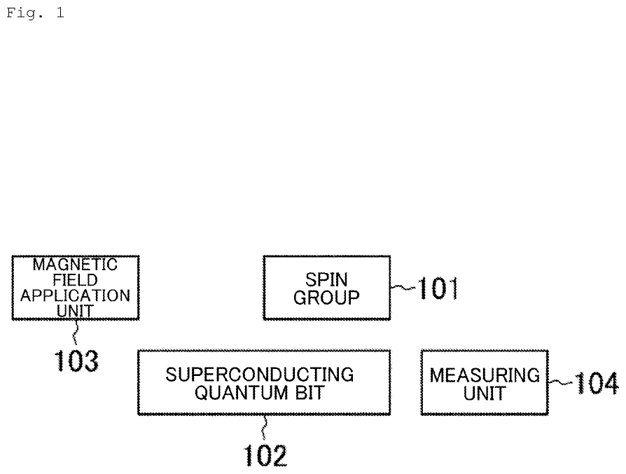

A temperature measuring device according to an embodiment of the present invention will now be described with reference to FIG. 1. The temperature measuring device includes a spin group 101 made up of a group of a plurality of particles having spins, and a superconducting quantum bit 102 for detecting magnetization of the spin group 101. The spin group 101 can be made up of a minute substance of a paramagnetic material including a spin group, such as diamond having a plurality of P1 centers (nitrogen impurities). The superconducting quantum bit 102 can be a superconducting magnetic flux quantum bit. The spin group 101 is disposed at an asymmetric position on the superconducting quantum bit 102. For example, the spin group 101 is disposed at a position deviated from a symmetrical position of the superconducting quantum bit 102 in a plan view.

The temperature measuring device includes a magnetic field application unit 103 for applying a magnetic field to the spin group 101 in a direction horizontal to the superconducting quantum bit 102, and a measuring unit 104 for measuring an energy of the superconducting quantum bit 102. The measuring unit 104 measures the energy of the superconducting quantum bit 102 indirectly by measuring the quantum state of the superconducting quantum bit 102.

Hereinafter, a more detailed description will be given. According to the above-described temperature measuring device, temperature measurement can be performed with high accuracy for a region smaller than before. In this temperature measuring device, the spin group 101 is used as a temperature measuring element. The spin group 101 is installed at a position as close as possible to the measuring object so that the difference between the value indicated by the spin group 101 and the temperature of the measuring object is minimized.

Although the paramagnetic material as the spin group 101 is not particularly limited, for example, without being limited to the P1 center included in the diamond crystal, it is also possible to use electron spins included in silicon doped with phosphorous, optical crystals doped with rare earth elements such as erbium, and fullerenes with nitrogen confined inside. When the measuring object contains spins, the temperature can be directly measured by utilizing the magnetization of the spins.

In embodiments of the present invention, a magnetic field is applied to a paramagnetic material including the spin group, and a change in polarization ratio of the spin group which changes with temperature is detected through a change in energy of superconducting quantum bits which are magnetically coupled to the spin group (refer to Reference Literature 1). The relationship between the spin polarization rate and the temperature can be expressed by the Brillouin function B_{S}(x) shown below.

$${B}_{S} ( x ) = \frac{2 S + 1}{2 S} coth \frac{( 2 S + 1 )}{2 S} - \frac{1}{2 S} coth \frac{x}{2 S} \\ x = \frac{g {μ}_{B} BS}{{k}_{B} T} \qquad Equation 1$$

Here, S is a magnitude of the spin constituting the spin group, g is a g factor of a sample, k_{B} is the Boltzmann constant, μ_{B} is a Bohr magneton, T is to temperature of a sensor substance including the spin group, and B is a magnetic field applied to the sample from the outside.

The energy change of the quantum bits due to the coupling with the magnetization of the spin group is measured by the superconducting quantum bits, and depends on the spin polarization rate. Since all constants appearing in the formula are known, the temperature T of the sensor substance can be determined by measuring the magnetization.

One of the features of the temperature measuring device according to embodiments of the present invention is to dispose the temperature measuring element including the spin group at a position asymmetric with respect to the rotation or reflection of the superconducting quantum bit with respect to the superconducting quantum bit having a Josephson junction. The magnetic field applied to the temperature measuring element (spin group) from the outside is in an in-plane direction with respect to the superconducting quantum bit. In many cases, the g factor of the spin has no anisotropy, and the magnetization direction of the spin group is the same in-plane direction as the magnetic field applied from the outside. However, if the temperature measuring element including the spin group is disposed at an asymmetric position on the superconducting quantum bit, interaction between the magnetic field generated by the magnetization of the spin group and the superconducting quantum bit occurs, and it becomes possible to measure a change in the magnetization.

When the g factor of the spin group has anisotropy, it is also possible to dispose a temperature measuring element including the spin group to cover all the superconducting quantum bits at a position having good symmetry. In this case, even when a magnetic field is horizontally applied to the plane, a magnetization component perpendicular to the plane appears due to anisotropy, and coupling occurs between the superconducting quantum bit and the magnetization component.

Further, when the superconducting quantum bit is made of a superconducting material having a large critical magnetic field such as niobium or a high-temperature superconductor, a large magnetic field can be applied in a direction perpendicular to the superconducting quantum bit. Also in this case, it is possible to dispose the temperature measuring element including the spin group at a position with good symmetry.

Since the energy change of the superconducting quantum bit depends on the magnitude of the coupled magnetization, it is sufficient to measure the energy. One of the methods of measuring the energy of the superconducting quantum bit is the measurement of the energy spectrum of the superconducting quantum bit. Since the state of the quantum bit is changed by an electromagnetic wave having a frequency equal to that of the energy, a spectrum is obtained by measuring the state of the quantum bit while sweeping the frequency of the electromagnetic wave to be irradiated, and the energy is known.

As another method, there is a method of utilizing the coherence of quantum bits. When the quantum bits are prepared in a quantum superposition state of a base state |g> and an excited state |e>, the phase difference between the two states develops as follows with respect to time t according to quantum mechanics.

$$\vert ψ ( t ) 〉 = \frac{1}{\sqrt{2}} ( \vert g 〉 + {e}^{- i \frac{E}{ℏ} t} \vert e 〉 ) \qquad Equation 2$$

Here, E is the energy of the quantum bit. When this state |μ(t)> is measured on the basis of X, phase information is obtained from the expected value P of the measurement described below, and the energy of the quantum bit can be known.

$${P = \vert \frac{1}{\sqrt{2}} ( 〈 g \vert + 〈 e \vert ) \vert ψ ( t ) 〉 \vert}^{2} = \frac{1}{2} + \frac{1}{2} cos \frac{Et}{} \qquad Equation 3$$

By utilizing the superconducting quantum bits having higher sensitivity than a conventional superconducting quantum interference device instead of a conventional superconducting quantum interference device for detecting a magnetization change due to temperature, highly accurate temperature measurement in a smaller sub-micrometer scale region is enabled.

### EXAMPLE

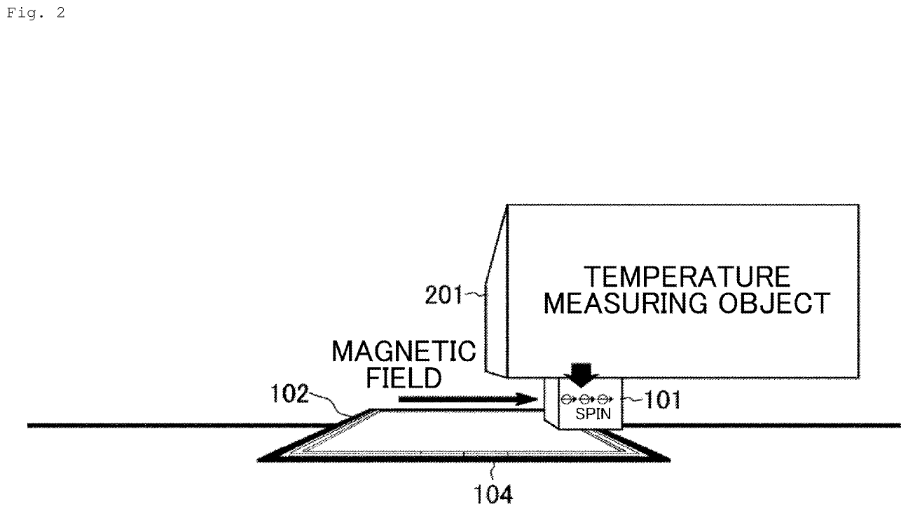

The following description will be made in more detail with reference to the examples. In the following description, a case where diamond fine particles having a P1 center are used as the spin group 101, and a superconducting magnetic flux quantum bit is used as the superconducting quantum bit 102 will be described as an example (FIG. 2).

Heat of a temperature measuring object 201 is transferred to the spin group 101 of the temperature measuring element by diamond fine particles. The diamond fine particles are brought into thermal contact with only the temperature measuring object 201. Since the heat capacity of the diamond fine particles is sufficiently smaller than that of the temperature measuring object 201, if sufficient thermal contact is prepared, the diamond fine particles and the temperature measuring object 201 reach thermal equilibrium in a short time. When a magnetic field is applied to the diamond fine particles, the magnetization generated by the spin group 101 depends on the temperature of the temperature measuring object 201. The magnetic flux generated by the magnetization penetrates the superconducting magnetic flux quantum bit (superconducting quantum bit 102) to change its energy. By reading the energy of the superconducting magnetic flux quantum bit by the measuring unit 104, the temperature of the temperature measuring object can be known.

The diamond fine particles have defects at various atomic levels, and electron spin is bound to the defects. For example, since the spin of electrons bound to the nitrogen impurity (P1 center) is S=½, the magnitude of magnetization due to the electron spin depends on the temperature as shown in the following formula. In the formula, M₀ represents saturation magnetization.

$$M ( t ) = {M}_{0} tanh ( \frac{g {μ}_{B} B}{2 {k}_{B} T} ) \qquad Equation 4$$

Diamond fine particles having a magnitude of about 100 nanometers to about 1 micrometer are disposed at asymmetric positions on the superconducting magnetic flux quantum bits having a magnitude of several micrometers, and a magnetic field is horizontally applied to the superconducting magnetic flux quantum bits by placing at an asymmetrical position. The magnetic field generated by the magnetization of the diamond fine particles penetrates the superconducting loop of the superconducting magnetic flux quantum bit, and is detected by the superconducting loop disposed as the measuring unit 104 around the superconducting loop of the superconducting magnetic flux quantum bit (superconducting quantum bit 102), and the magnitude of the magnetization of the diamond fine particles can be measured.

$$Energy of superconducting magnetic flux quantum bit is E = \sqrt{{Δ}^{2} + {ε}^{2}} . ε depends on magnetic flux Φ penetrating the quantum bit and is \frac{d ε}{d Φ} = 2 {I}_{p} . \\ Here , {I}_{p} is dimension of permanent current flowing through superconducting loop . Thus , ε ( T ) ∝ tanh ( \frac{g {μ}_{B} B}{2 {k}_{B} T} ) \\ is expressed , and it is known that the energy of quantum bit changes by the temperature change .$$

This energy change is detected by spectrum measurement of quantum bits or measurement of phase difference of quantum states.

The detection of the phase difference in the quantum state will be described below. The superconducting magnetic flux quantum bit is prepared in a quantum superposition state of the base state and the excited state. The phase difference θ between the base state and the excited state is proportional to the energy of the quantum bits, and changes with respect to time t as follows, while the quantum coherence is maintained.

$$θ = \frac{E}{ℏ} t \qquad Equation 6$$

In order to measure the phase difference θ, measurement capable of performing a Ramsay interference is performed by the following procedure.
1. After initializing the superconducting quantum bits to the base state, π/2 pulses are applied to prepare a quantum superposition state (π pulses are microwave pulses having a length for exciting the superconducting quantum bits from the base state to the excited state, and the length of π/2 pulses is half of the microwave pulses).
2. Wait for a predetermined time τ.
3. τ/2 pulses are applied to the superconducting quantum bits again in the same phase as the first pulse.
4. The state of the superconducting quantum bit is measured.
5. 1 to 4 are repeated to obtain the probability of being in the excited state.

Here, the probability P and of the superconducting quantum bit in the excited state have the following relationship.

$$P = {P}_{B} + \frac{V}{2} cos [ ( \frac{E}{} - ω ) τ ] {e}^{- \frac{τ}{{T}_{2}}} \qquad Equation 7$$

Here, ω is the frequency of the pulse, V is the visibility of measurement, P_{B} is the offset of probability, and T₂ is the coherence time. The energy of the superconducting magnetic flux quantum bit varies with the magnetic flux passing through the loop. The energy E is known from the measurement of P, and the temperature is known from the magnitude of the magnetization of the spin group that causes the energy shift. The pulse frequency, the pulse interval ω, and the external magnetic field B are parameters that can be selected by a measurer, but in order to measure with the best sensitivity, the parameters may be selected to satisfy the following conditions.

$$τ = {T}_{2} \\ ( \frac{E}{} - ω ) {T}_{2} = \frac{π}{2} \\ 1 = \frac{g {μ}_{B} B}{{k}_{B} T} tanh ( \frac{g {μ}_{B} B}{2 {k}_{B} T} ) \qquad Equation 8$$

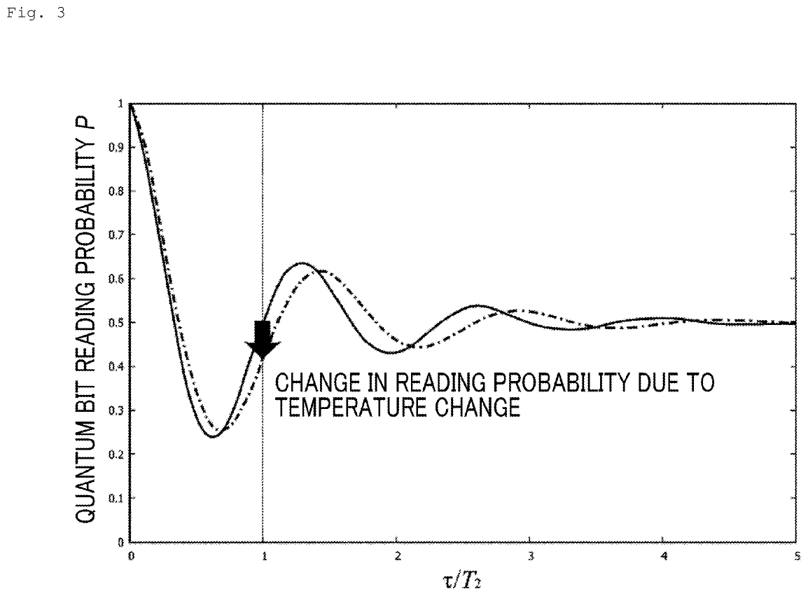

FIG. 3 shows changes in temperature and reading probability when the quantum coherence of quantum bits is utilized. When the magnetization is changed by the temperature change of the minute substance of the paramagnetic material having the spin group, the magnetic field interacting with the superconducting quantum bit is changed and energy shift occurs. When a quantum superposition state is prepared, the phase is shifted depending on the energy shift. Since the phase of the quantum vibration observed with respect to the change of τ changes with temperature and the reading probability changes from a solid line state to a one-dot broken line state, the temperature can be known by reading the quantum bit.

Next, a temperature measuring method using the above-described temperature measuring device will be described.

First, as a first process, diamond fine particles, which are temperature measuring elements of the temperature measuring device, are brought into thermal contact with the temperature measuring object. The superconducting magnetic flux quantum bit and the measuring unit are cooled to be equal to or lower than the superconducting transition point and E/k_{B} of the material constituting each of them, and are magnetically coupled with the magnetization of the diamond fine particles.

Next, in a second process, a constant magnetic field is applied to the diamond fine particles (spin group) from an external magnetic field application unit.

Next, in a third process, for example, the energy of the superconducting magnetic flux quantum bit is measured to obtain a magnetic flux due to the magnetization of the diamond fine particles.

Next, in a fourth process, the magnitude of magnetization of the diamond fine particles obtained is converted into temperature.

By the temperature measuring method by the first to fourth processes, the temperature of a minute region of about the volume (1 aL or less) of the diamond fine particles can be measured.

As described above, according to embodiments of the present invention, since the spin group consisting of the group of the plurality of particles having spins is used as a temperature measuring element and magnetization of the spin group is detected by the superconducting quantum bit, it is possible to provide the temperature measuring device which has a small magnitude and can be installed in the vicinity of the measuring object. According to embodiments of the present invention, it is possible to measure the temperature of a minute region of a sub-micrometer scale, which has been impossible in the related art, with high accuracy.

Also, it is apparent that the present invention is not limited to the embodiment described above, and many modifications and combinations can be carried out by those having ordinary knowledge in the art within the technical idea of the present invention.

H. Toida et al., “Electron paramagnetic resonance spectroscopy using a single artificial atom”, Communications Physics, vol. 2, Article number: 33, 2019.

### REFERENCE SIGNS LIST

101 Spin group
102 Superconducting quantum bits
103 Magnetic field application unit
104 Measuring unit.

1-5. (canceled)

6. A temperature measuring device comprising:
a spin group made up of a plurality of particles having spins;
a superconducting quantum bit configured to detect magnetization of the spin group;
a magnetic field applicator configured to apply a magnetic field to the spin group in a direction horizontal to the superconducting quantum bit; and
a measuring device configured to measure energy of the superconducting quantum bit.

7. The temperature measuring device according to claim 6, wherein the spin group is disposed at an asymmetric position on the superconducting quantum bit.

8. The temperature measuring device according to claim 7, wherein the spin group is disposed at a position shifted from a symmetrical position of the superconducting quantum bit in a plan view.

9. The temperature measuring device according to claim 7, wherein the measuring device is configured to measure a quantum state of the superconducting quantum bit.

10. The temperature measuring device according to claim 7, wherein the superconducting quantum bit is a superconducting magnetic flux quantum bit.

11. The temperature measuring device according to claim 6, wherein the measuring device is configured to measure a quantum state of the superconducting quantum bit.

12. The temperature measuring device according to claim 6, wherein the superconducting quantum bit is a superconducting magnetic flux quantum bit.

13. The temperature measuring device according to claim 6, wherein a magnetic flux due to magnetization of the spin group is obtained from the energy of the superconducting quantum bit that is measured by the measuring device, and wherein the magnetic flux is converted into a temperature measurement.

14. The temperature measuring device according to claim 6, wherein the plurality of particles of the spin group is a plurality of diamond particles.

15. The temperature measuring device according to claim 14, wherein the plurality of diamond particles has a plurality of P1 centers.

16. A method comprising:
detecting, by a superconducting quantum bit, magnetization of a spin group, the spin group being made up of a plurality of particles having spins;
applying, by a magnetic field applicator, a magnetic field to the spin group in a direction horizontal to the superconducting quantum bit; and
measuring, by a measuring device, energy of the superconducting quantum bit to determine a magnetic flux; and
converting the magnetic flux into a temperature measurement.

17. The method according to claim 16, wherein the spin group is disposed at an asymmetric position on the superconducting quantum bit.

18. The method according to claim 17, wherein the spin group is disposed at a position shifted from a symmetrical position of the superconducting quantum bit in a plan view.

19. The method according to claim 17, wherein the measuring device is configured to measure a quantum state of the superconducting quantum bit.

20. The method according to claim 17, wherein the superconducting quantum bit is a superconducting magnetic flux quantum bit.

21. The method according to claim 16, wherein the measuring device is configured to measure a quantum state of the superconducting quantum bit.

22. The method according to claim 16, wherein the superconducting quantum bit is a superconducting magnetic flux quantum bit.

23. The method according to claim 16, wherein the plurality of particles of the spin group is a plurality of diamond particles.

24. The method according to claim 23, wherein the plurality of diamond particles each have nitrogen impurities.
